(19) United States
(12) Patent Application Publication
(10) Pub. No.: US 2015/0069178 A1
(43) Pub. Date: Mar. 12, 2015

(54) FUSELAGE-MOUNTED LANDING GEAR ASSEMBLY FOR USE WITH A LOW WING AIRCRAFT

(71) Applicant: The Boeing Company, Seal Beach, CA (US)

(72) Inventors: Stephen T. Brown, Everett, WA (US); Michael Lane Drake, Bellevue, WA (US); Christopher R. Holtorf, Marysville, WA (US); Justin Cottet, Snohomish, WA (US)

(73) Assignee: The Boeing Company, Seal Beach, CA (US)

(21) Appl. No.: 14/021,301

(22) Filed: Sep. 9, 2013

(51) Int. Cl. B64C 25/12

(52) U.S. Cl. CPC B64C 25/12
USPC 244/102 R

(57) ABSTRACT

An aircraft comprises at least one wing comprising a trailing edge flap that is selectively moveable between a stowed position and an extended position. The aircraft also includes a fuselage comprising a first gear door on a side of the fuselage and a second gear door on a bottom of the fuselage. The first gear door is moveable in a gear door envelope between a closed position and an open position. The wing is coupled to the fuselage in a low-wing configuration. A landing gear assembly is coupled to the fuselage and is selectively moveable between a retracted position and a deployed position. The trailing edge flap may be extended simultaneously with, before, or after deployment of the landing gear assembly and opening of the first gear door.

### BACKGROUND

The field of the present disclosure relates generally to an aircraft, and, more specifically, to fuselage-mounted landing gear for use with a low wing aircraft.

An effective landing gear design for an aircraft should provide an optimum combination of sufficient overall functional strength, a geometric arrangement for adequate ground maneuvering and landing stability, a lowest possible weight, and a highest possible wing efficiency when retracted. On any low wing or other aircraft in which the main landing gear is stored or attached to a wing of the aircraft, at least one of the above goals may be at risk and may be difficult to optimize. In the case of wing-mounted landing gear configurations, for example, the wing efficiency goal may be compromised.

To enhance stability and to prevent wallowing during ground maneuvers, an aircraft's main landing gear must be placed sufficiently outboard of the side of the body of the aircraft. On low wing aircraft this is usually not a problem because a gear post can be attached to the wing, outboard of the side of the body of the aircraft. However, wing-mounted landing gear assemblies generally require a large physical footprint in the inboard area of the wing for storage when retracted, which significantly increases the overall area of the wing root. The increased area of the wing root increases the overall weight of the aircraft and may decrease the potential efficiency of the wing.

In addition, fuselage mounted landing gear (FMLG) designs, common on high and middle wing aircraft, may be heavy and create significant drag relative to a low wing aircraft. Typically, to ensure the landing gear is sufficiently outboard of the aircraft body, the frame of the landing gear is extended beyond the side of the body of the aircraft. More specifically, the top of the gear struts are coupled to trunnions mounted to the gear frames. The gear assembly pivots around these trunnions and is stowed inside the body. However, the increased gear components increase the weight and frontal area of the wing. The increased area increases the drag induced on the aircraft.

To minimize the drag associated with the increase in frontal area, at least some aircraft includes a fairing that extends about the external structure, which also increases the structural weight of the gear assembly. Despite streamlining efforts, total drag is still dependent upon frontal area and surface area, both of which are increased by the fairings. Large fairings increase aircraft wetted and frontal areas, and, accordingly, increases the parasite drag, which adversely effects the efficiency of the aircraft. Moreover, for middle wing configurations, the main landing gear fairing may be positioned adjacent to the lower wing surface, which may create additional interference drag. Similarly, the main landing gear doors may interfere with the trailing edge flap of the wing. To overcome the increased drag, a multi-part flap may be needed. However such flap assemblies increase aircraft weight and reduce efficiency.

Other configuration with lower wing and body mounted main landing gear have not addressed the significant impact to aft cargo volume, ability to deploy without power, or the adjacent wing flap interference issues.

Therefore, it would be advantageous to have a fuselage mounted landing gear assembly for a low wing aircraft that takes into account one or more of the issues discussed above, as well as possibly other issues.

### BRIEF DESCRIPTION

In one aspect, a landing gear assembly for use with a low wing aircraft is provided. The landing gear assembly comprises a truck assembly and a shock strut coupled to and configured to support the truck assembly. The landing gear assembly further comprises a retraction assembly coupled to the shock strut and to the truck assembly. The retraction assembly is configured to selectively move the landing gear assembly between a retracted position and a deployed position. The retraction assembly comprises a main trunnion brace having a first end and a second end, wherein the first end is coupled to a fuselage of the aircraft at a first pivot point and the second end is coupled to the truck assembly. The main trunnion brace is configured to position the truck assembly, the shock strut, and the retraction assembly fully within the fuselage of the aircraft with a side pivoting motion.

In another aspect, an aircraft is provided. The aircraft comprises at least one wing comprising a trailing edge flap that is selectively moveable between a stowed position and an extended position. The aircraft also includes a fuselage comprising a first gear door on a side of the fuselage and a second gear door on a bottom of the fuselage. The first gear door is moveable in a gear door envelope between a closed position and an open position. The wing is coupled to the fuselage in a low-wing configuration. A landing gear assembly is coupled to the fuselage and is selectively moveable between a retracted position and a deployed position. The trailing edge flap may be extended simultaneously with, before, or after deployment of the landing gear assembly and opening of the first gear door.

In yet another aspect, a method of enhancing the maneuverability and efficiency of an aircraft is provided. The method comprises providing a fuselage including a first gear door on a side of the fuselage and a second gear door on a bottom of the fuselage. The first gear door is moveable in a gear door envelope between a closed position and an open position. The method further comprises coupling a landing gear assembly to the fuselage, wherein the landing gear assembly is selectively moveable between a retracted position and a deployed position. At least one aft swept wing is coupled to the fuselage in a low wing configuration. The at least one aft swept wing includes a trailing edge flap that is coupled adjacent a rear spar of a wing main box. The trailing edge flap is selectively moveable between a stowed position and an extended position, wherein the trailing edge flap may be extended simultaneously with, before, or after deployment of the landing gear assembly and opening of the first gear door.

### BRIEF DESCRIPTION OF THE DRAWINGS

FIG. 1 is a flow diagram of an exemplary aircraft production and service methodology;

FIG. 2 is a block diagram of an exemplary aircraft;

FIG. 3 is a block diagram of an exemplary fuselage mounted landing gear (FMLG) assembly that may be used with the aircraft shown in FIG. 2;

FIG. 4 is an overlay of a known low wing aircraft wing planform with an exemplary low wing aircraft wing planform that may be used with the aircraft shown in FIG. 2;

FIG. 5 is an isometric view of an exemplary FMLG assembly in a deployed position;

FIG. 6 is a rear view of the FMLG assembly shown in FIG. 5 in both the deployed and retracted positions in accordance with the exemplary embodiment shown in FIG. 5;

FIG. 7 is a side view of the FMLG assembly shown in FIG. 5 in both the deployed and retracted positions and looking inwardly towards the aircraft;

FIGS. 8A-8D are rear views of a retraction process for the FMLG assembly shown in FIGS. 5; and

FIG. 9 is a side view of the FMLG assembly interface along a wing of a low wing aircraft.

### DETAILED DESCRIPTION

The implementations described herein relate to assemblies and methods that facilitate improving the efficiency of an aircraft wing by reducing the interference between the wing, landing gear doors, and landing gear assembly of a low wing aircraft. In an exemplary implementation, the aircraft includes at least one wing that includes a trailing edge flap that is selectively moveable between a stowed position and an extended position. The aircraft also includes a fuselage that includes a first gear door on a side of the fuselage and a second gear door on a bottom of the fuselage. The first gear door defines a first gear door envelope between a closed position and an open position. A landing gear assembly is coupled to the fuselage and is selectively moveable between a retracted position and a deployed position. The trailing edge flap may be extended simultaneously with, before, or after deployment of the landing gear assembly and opening of the first gear door, such that the trailing edge flap and first gear door are operable between their stowed and extended positions, and between their closed and open positions without interfering with one another.

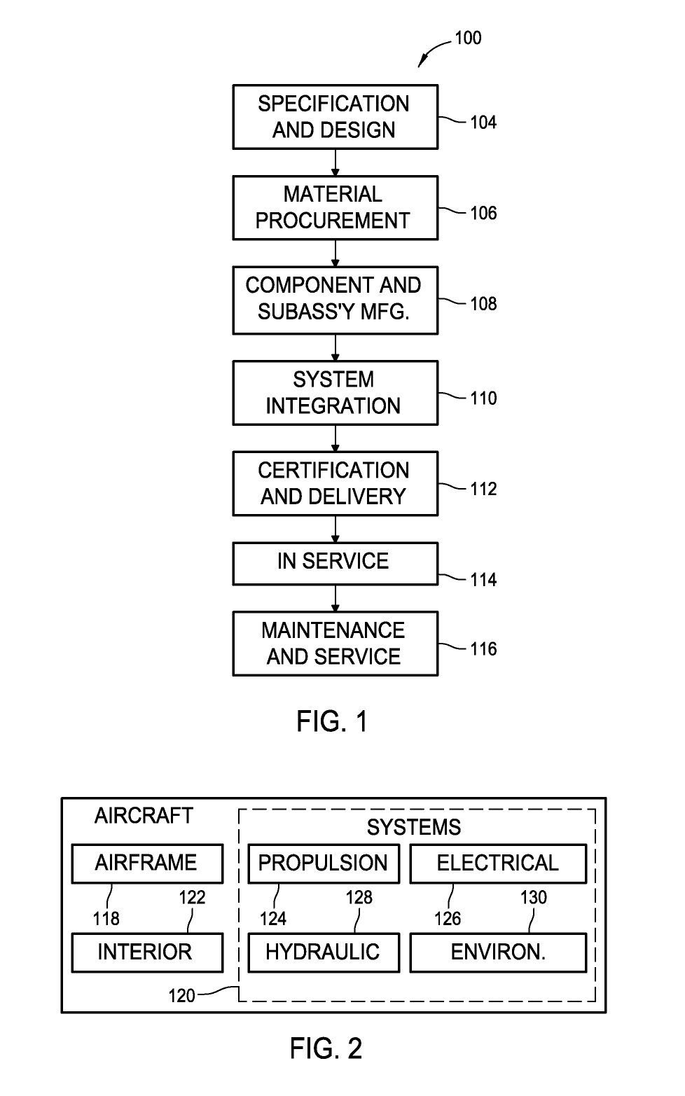

Referring to the drawings, FIG. 1 is a flow diagram of an aircraft manufacturing and service method 100 that may be used with an aircraft (not shown in FIG. 1). During pre-production, aircraft manufacturing and service method 100 may include specification and design data 104 associated with the aircraft being manufactured. Other materials associated with the airframe may be procured 106. During production, component and subassembly manufacturing 108 and system integration 110 of the aircraft occurs, prior to the aircraft entering its certification and delivery process 112. Upon successful satisfaction and completion of airframe certification, the aircraft may be placed in service 114. While in service by a customer, the aircraft is scheduled for periodic, routine, and scheduled maintenance and service 116, including any modification, reconfiguration, and/or refurbishment, for example.

Each portion and process associated with aircraft manufacturing and/or service method 100 may be performed or completed by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

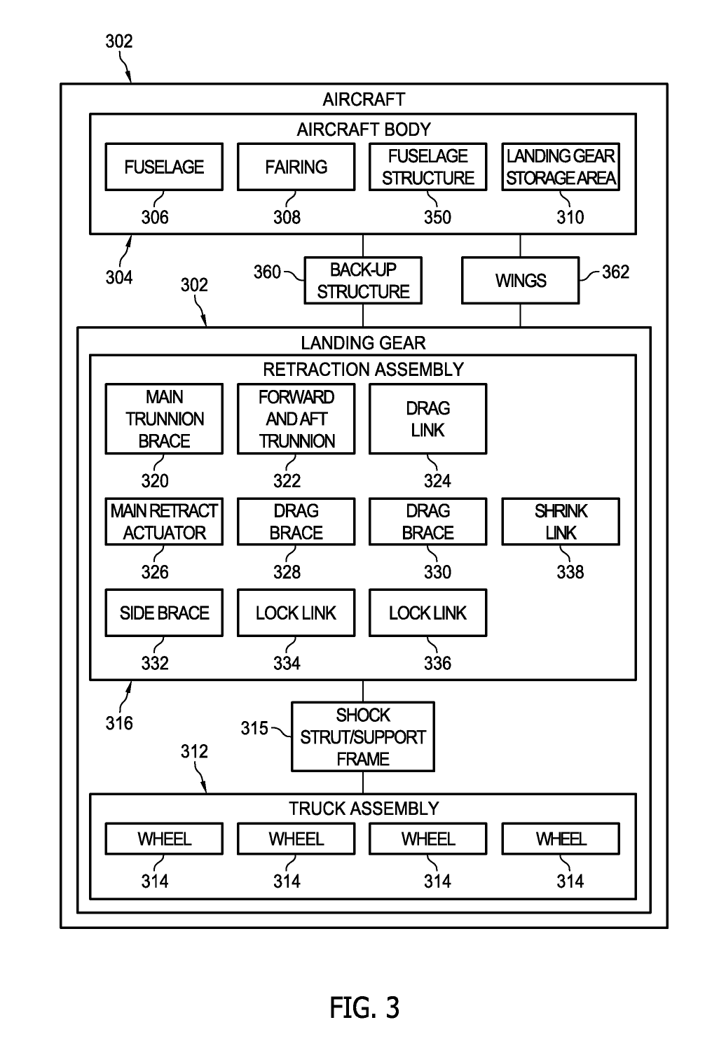

As shown in FIG. 2, an aircraft 102 produced via method 100 may include an airframe 118 including a plurality of systems 120 and an interior 122. Examples of high-level systems 120 may include a propulsion system 124, an electrical system 126, a hydraulic system 128, and/or an environmental system 130. Any number of other systems may be included. Although aircraft 102 is illustrated, in alternative implementations, the technology may be used with non-aviation industries, such as the automotive and/or automotive industries.

Moreover, the apparatus and methods described herein may be employed during any one or more of the stages of method 100. For example, components or subassemblies corresponding to component production process 108 may be fabricated or manufactured in a manner similar to components or subassemblies produced while aircraft 102 is in service. Also, one or more apparatus implementations, method implementations, or a combination thereof may be utilized during the production stages 108 and 110, for example, by substantially expediting assembly of, and/or reducing the cost of assembly of an aircraft. Similarly, one or more of apparatus implementations, method implementations, or a combination thereof may be utilized while the aircraft is being serviced or maintained, for example, during scheduled maintenance and service 116.

As used herein, the term “aircraft” may include, but is not limited to only including, airplanes, unmanned aerial vehicles (UAVs), gliders, helicopters, and/or any other object that travels thorough airspace.

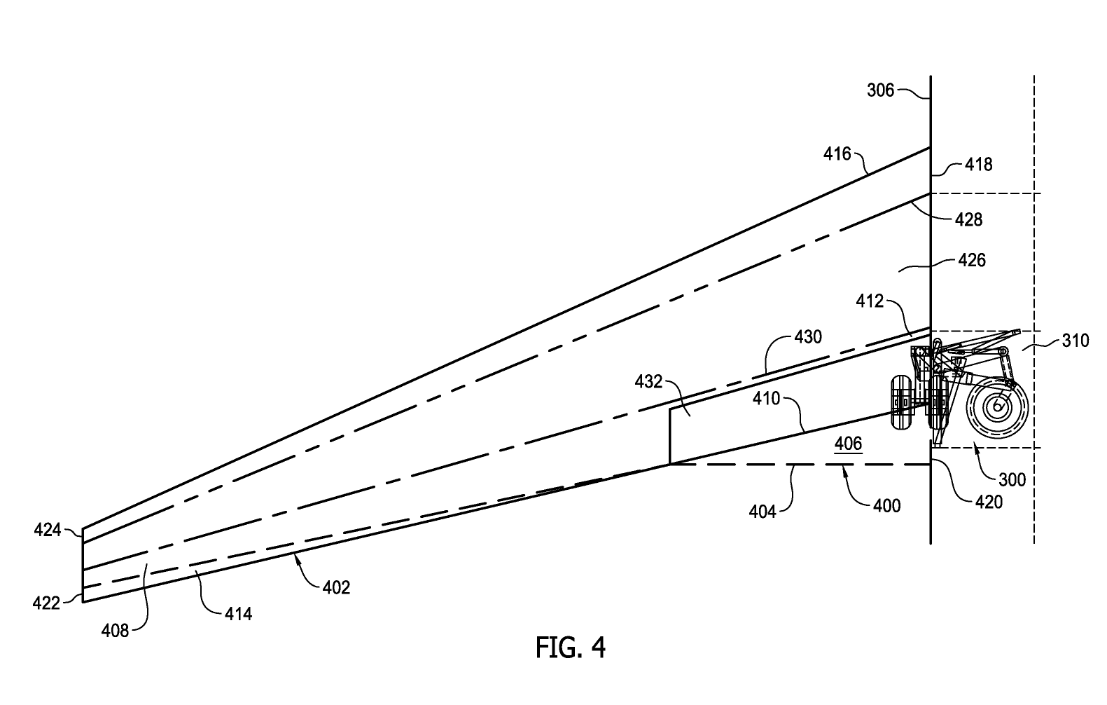

FIG. 3 is a block diagram of an exemplary landing gear 300 that may be used with an aircraft 302. In the exemplary embodiment, landing gear 300 is a fuselage mounted landing gear (FMLG) that is mounted to and that is stored within an aircraft body 304 of aircraft 302. In the exemplary implementation, a fairing 308 extends from fuselage 306 to define a landing gear storage area 310 for storing landing gear 300 in a retracted position. Alternatively, landing gear 300 is selectively moveable between a deployed position and a retracted position when stored in landing gear storage area 310.

In the exemplary implementation, landing gear 300 includes a truck assembly 312, a retraction assembly 316 and a shock strut 315 that connects truck assembly 312 to retraction assembly 316. Truck assembly 312 includes a plurality of wheels 314. For example, in the exemplary implementation, assembly 312 includes between two to four wheels. Retraction assembly 316 is coupled to truck assembly 312 and to aircraft body 304.

Retraction assembly 316 may include any number of components, such as a main trunnion brace 320, a forward and aft trunnion 322, a drag link 324, at least one main actuator 326, a set of drag braces 328 and 330, a side brace 332, a pair of lock links 334 and 336, and a shrink link 338. The various components of retraction assembly 316 function together to selectively move truck assembly 312 and landing gear 300 as a whole between the deployed position and the retracted position. When in the retracted position, landing gear assembly 300 may be stored in landing gear storage area 310 within aircraft body 304. More specifically, in the exemplary embodiment, landing gear assembly 300 is mounted to fuselage 306 and is stored entirely within landing gear storage area 310 within fuselage 306 such that landing gear assembly 300 is not stored within either wing 362 extending from fuselage 306.

In the exemplary embodiment, a fuselage structure 350 releasably secures landing gear 300 within storage area 310, and a backup structure 360 couples landing gear 300 to aircraft body 304.

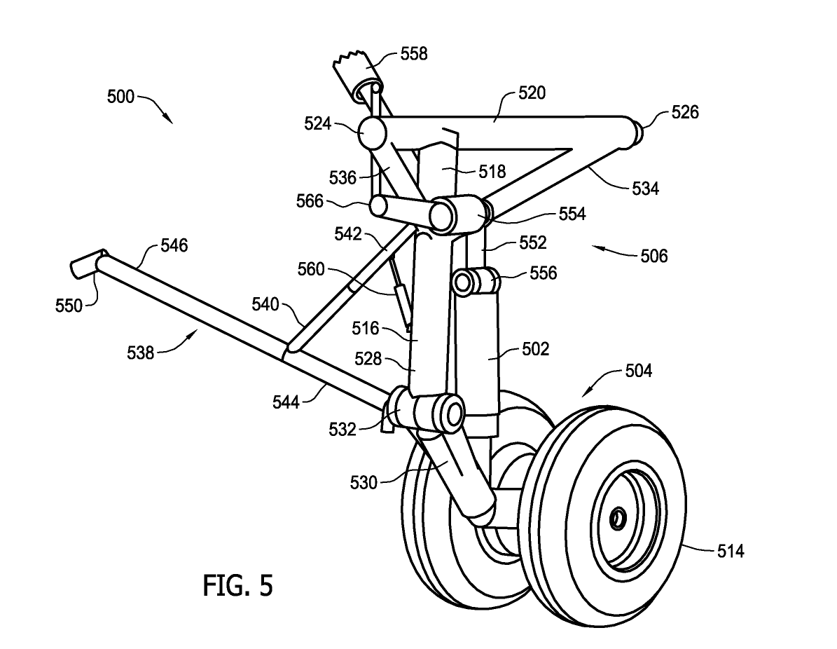

FIG. 4 illustrates an overlay comparison of a known low wing aircraft wing planform 400 and an exemplary low wing planform 402 for use with low wing aircraft 302 (not shown in FIG. 4). More specifically, wing planform 400 is an aft-swept wing planform for a low wing aircraft (not shown) that includes a wing-mounted landing gear assembly, and wing planform 402 is a wing planform for low wing aircraft 302 including fuselage mounted landing gear assembly 300 located in storage area 310 of fuselage 306. Wing planform 400 includes a trailing edge 404, illustrated in broken lines, an inboard portion 406, and an outboard portion 408. Wing planform 402 is an aft-swept wing that includes a trailing edge 410, an inboard portion 412, and an outboard portion 414. Planforms 400 and 402 have a common leading edge 416 and a similar main structural load carrying box 426 with a front spar 428 and a rear spar 430. Moreover, planform 402 includes a wing root 418 that is shorter than a wing root 420 of planform 400. Also, planform 402 includes a wing tip chord 422 that is longer than a wing tip chord 424 of planform 400.

In the exemplary embodiment, inboard portion 406 is larger than inboard portion 412 and wing root 420 is longer than wing root 418 to enable storage of a wing-mounted landing gear. However, as is shown, larger inboard areas of aircraft wings increate additional drag and increase the overall weight by storing the landing gear in the wing. As such, the larger inboard area of current aircraft wings is generally less efficient that wing 402. In the exemplary embodiment, outboard portion 414 is larger than outboard portion 408. However, because wing planform 400 and wing planform 402 have substantially similar total areas, a difference in the area defined between inboard portion 406 and inboard portion 412 is approximately equal to a difference in the areas defined between outboard portion 408 and outboard portion 414.

Generally, increasing the area of outboard portion 414 by lengthening wing tip chord 424 to create wing tip chord 422 and decreasing the area of inboard portion 412 by shortening wing root 420 to create wing root 418 facilitates increasing the overall efficiency of wing planform 402 and aircraft 302. More specifically, an increased outboard portion 414 area and an decreased inboard portion 412 area of exemplary wing planform 402 facilitates reducing wave drag created by thicker inboard portion 406 and facilitates reducing induced drag at the same or higher span loading of wing planform 400 with a more efficient outboard wing load distribution. Inboard portion 406 is not required for wing planform 402 because planform 402 does not include a storage area in the wing for a landing gear assembly or added inboard wing area 406 to mount an inboard wing flap 432 with space behind wing box 426 to clear the deployed gear and gear doors (not shown in FIG. 4). Inboard wing flap 432 for planform 402 is generally mounted adjacent rear spar 430 of wing box 426. As a result, the area of inboard portion 406 is redistributed to outboard portion 414 to facilitate increasing wing planform 402 efficiency over planform 400 efficiency of a substantially similar total wing area.

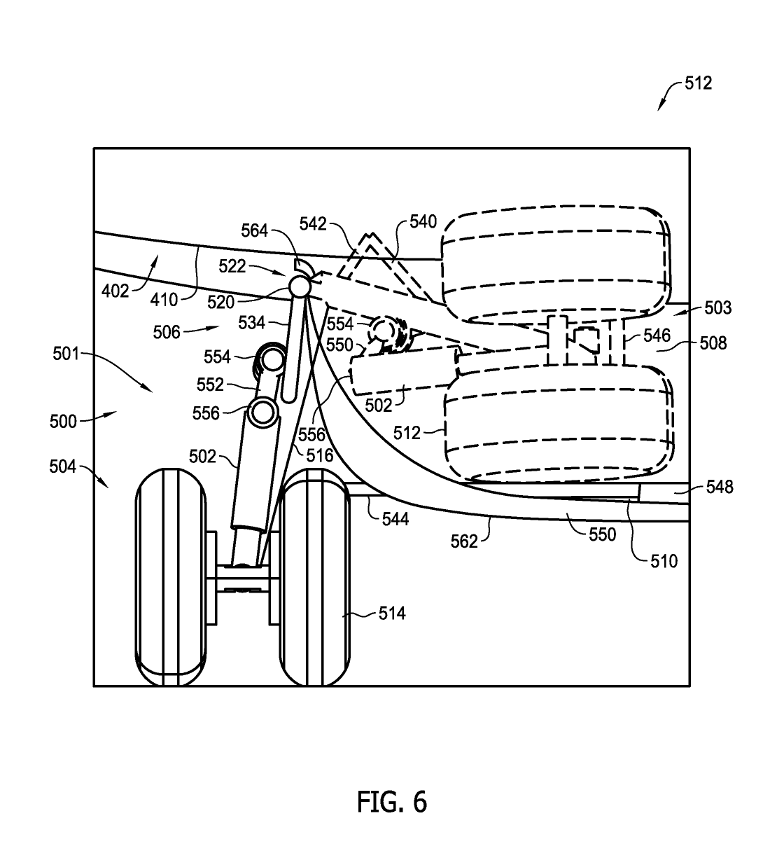

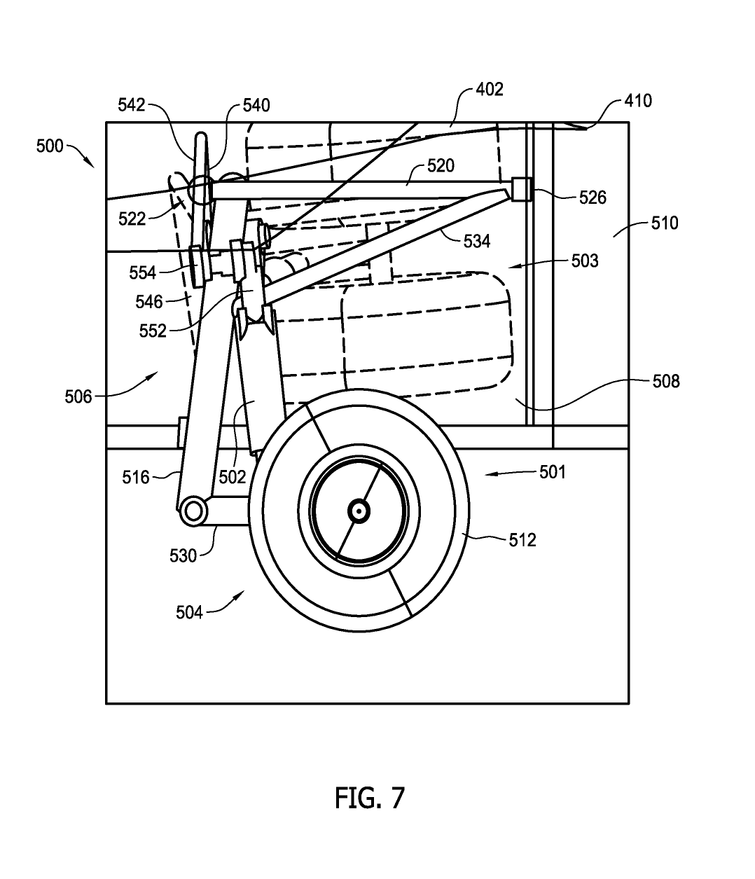

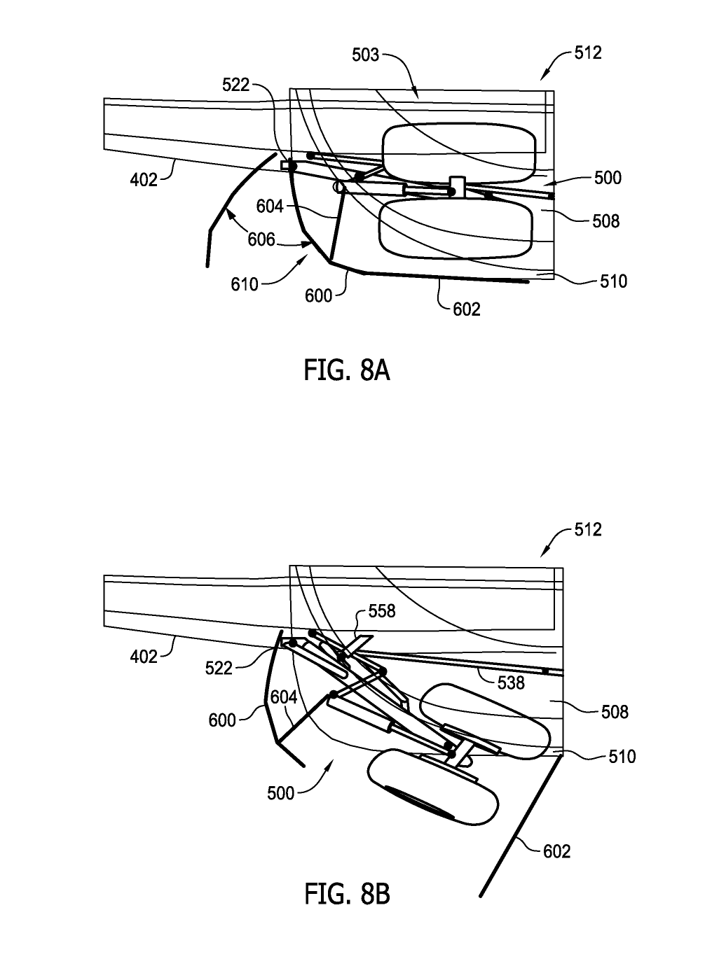

FIGS. 5-7 illustrate an exemplary landing gear assembly 500 that may be used with aircraft 302. In particular, FIG. 5 is an isometric view of a fuselage mounted landing gear (FMLG) assembly 500 for use with a low wing aircraft (not shown in FIG. 5), FIG. 6 is a rear view of FMLG assembly 500 with a deployed position 501 illustrated in solid lines and a retracted position 503 illustrated in broken lines, and FIG. 7 is a side view of FMLG assembly 500 looking inwardly towards the aircraft with deployed position 501 illustrated in solid lines and retracted position 503 illustrated in broken lines. Landing gear assembly 500 may be a FMLG assembly. In the exemplary embodiment, FMLG assembly 500 includes a shock strut 502 for supporting a truck assembly 504, and a retraction assembly 506 for selectively moving shock strut 502 and truck assembly 504 about a longitudinal hingeline 522 in a primarily sideways motion between deployed position 501 for use in take-off/landing/taxiing and retracted position 503 for storage in a landing gear storage area 508 in a fuselage 510 of an aircraft 512.

Truck assembly 504 may include a plurality of wheels 514. In the exemplary embodiment, truck assembly 504 has two wheels. Alternatively, truck assembly 504 may have a different number of wheels, for example, four wheels or six wheels. Generally, truck assembly 504 has any number of wheels that facilitate operation of FMLG assembly 500 as described herein.

Truck assembly 504 is deployed sufficiently outboard of the side of fuselage 510 of aircraft 512 to prevent aircraft 512 from tipping over during ground maneuvering, and will remain stable throughout all aircraft 512 operations. On an aircraft where it is not practical to use wing-mounted landing gear, the landing gear is usually mounted to and completely stored within the body of the aircraft (as will be explained hereinafter, the body of aircraft 512 may include fuselage 510 alone or fuselage 510 as expanded by a fairing). Retraction assembly 506 illustrated in FIGS. 5-7 enables truck assembly 504 to be moved between deployed position 501 that is sufficiently outboard of fuselage 510 to meet all stability requirements and, at the same time, enables complete or substantially complete storage of FMLG assembly 500 within fuselage 510 when FMLG assembly 500 is in retracted position 503.

Retraction assembly 506 may include a main trunnion brace 516 that is positioned at an angle to the vertical when FMLG assembly 500 is in deployed position 501. A first end 518 of main trunnion brace 516 may be coupled to fuselage 510 by a forward and aft trunnion 520 at a first pivot line 522. Forward and aft trunnion 520 includes a forward portion 524 and an aft portion 526 separated from forward portion 524 sufficiently to handle the torsional loads of FMLG assembly 500. A second end 528 of main trunnion brace 516 is pivotally coupled to a drag link 530 at a pivot point 532. Drag link 530 is also pivotally coupled to truck assembly 504. In the exemplary embodiment, retraction assembly 506 also includes drag braces 534 and 536 that are configured to support shock strut 502 and forward and aft trunnion 520. Drag braces 534 and 536 are supported by a side brace 538, which is coupled to main trunnion brace 516 at a first position by a pair of lock links 540 and 542. Side brace 538 includes a first end 544 coupled to second end 528 of main trunnion brace 516 at a second position, wherein the second position is pivot point 532. A second end 546 of side brace 538 is pivotally coupled to a support 548 of aircraft fuselage 510 at a pivot point 550.

FMLG assembly 500 further includes a shrink link 552 having a first end 554 pivotally coupled to main trunnion brace 516 and a second end 556 pivotally coupled to telescoping shock strut 502. In the exemplary embodiment first end 554 is operates to extend or retract shock strut 502 by a parallel linkage 566. Alternatively, first end 554 may be operated by an actuator (not shown). A main gear actuator 558 is coupled between main trunnion brace 516 and fuselage 510 and is configured to retract FMLG assembly 500 into storage area 508 after take-off A lock actuator 560 is operable to facilitate locking and unlocking lock links 540 and 542 during retraction and deployment of FMLG assembly 500.

When FMLG assembly 500 is in deployed position 501, it is far enough outboard of the side of fuselage 510 to ensure stability during taxi and landing. FMLG assembly 500 also provides stable 3-dimensional support which effectively resists loads and moments from any direction. When FMLG assembly 500 is retracted by operation of main actuator 558, FMLG assembly 500 is retracted well within fuselage 510 when lock links 540 and 542 are unlocked. The size and weight of FMLG assembly 500 is minimized by limiting variation in the mechanical advantage of the retract actuator.

As shown in FIG. 6, fuselage 510 also includes a fairing 562 to encompass FMLG assembly 500 in retracted position 503, when necessary. In accordance with the exemplary embodiment, however, fairing 562 may be much closer to fuselage 510 as compared to current fuselage mounted landing gear. Large aircraft commonly have increased fuselage sizes, which may reduce the need for fairing 562. Fuselage 510 may also include at least one FMLG trunnion fusing option to prevent FMLG assembly 500 from damaging the fuel tanks (not shown) or entering the passenger compartment (not shown) of aircraft 512. In the exemplary embodiment, fuselage 510 includes a fusing track 564 coupled to fuselage 510 proximate forward portion 524 of forward and aft trunnion 520. Fusing track 564 is configured to guide forward portion 524 and main trunnion brace 516 outboard from fuselage 510 in the aft direction in the case of a vertical or drag event. Aft portion 526 of forward and aft trunnion 520 is coupled to fuselage at an aft wheel well bulkhead (not shown) in a ball joint to facilitate outboard rotation of forward and aft trunnion 520. Alternatively, fusing track 564 may be located at aft portion 526 of forward and aft trunnion 520 and forward portion 524 may be coupled to fuselage 510 by a ball joint to facilitate outboard rotation of forward and aft trunnion 520.

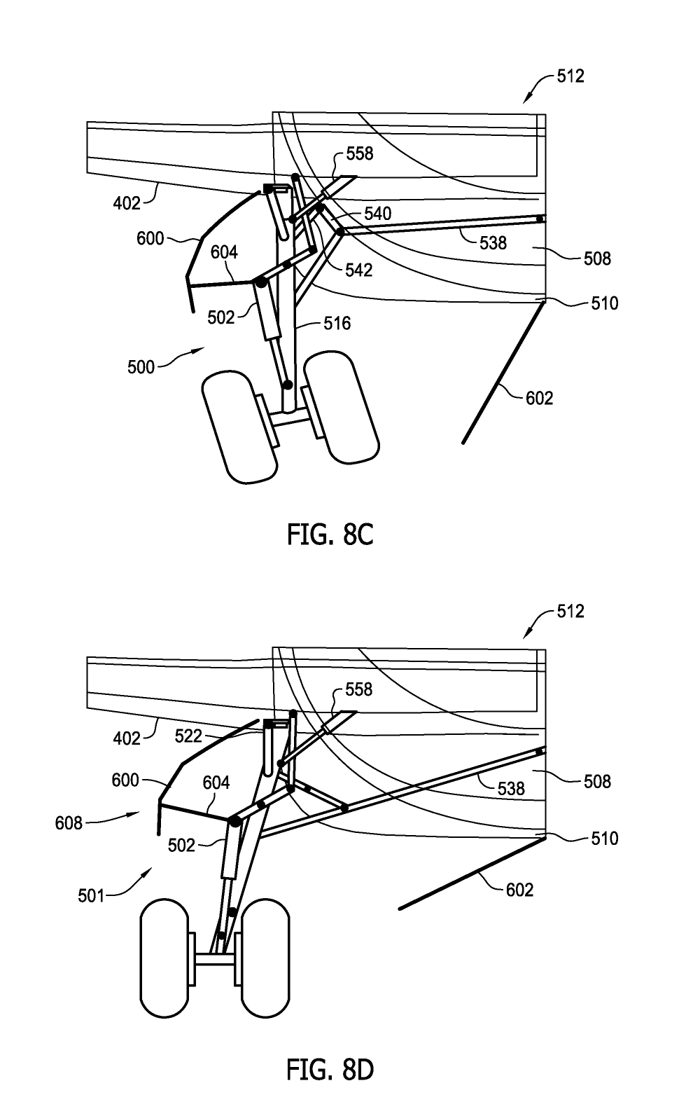

FIGS. 8A-8D illustrate FMLG assembly 500 during the deployment process on approach of aircraft 512 prior to landing. In particular, FIG. 8A shows FMLG assembly 500 in retracted position 503 within storage area 508 of fuselage 510, FIGS. 8B and 8C show FMLG assembly 500 in subsequent stages of deployment, and FIG. 8D shows FMLG assembly 500 in deployed position 501. The reduced length when retracted enables a similar body storage volume 508 as a wing mounted gear design, reducing aft cargo storage volume impact.

In the exemplary embodiment, fuselage 510 includes a first gear door 600 located on the side of fuselage 510 and a second gear door 602 located on the bottom of fuselage 510. In cases where aircraft 512 includes fairing 562 (not shown in FIGS. 8A-8D), doors 600 and 602 may be part of fairing 562. Doors 600 and 602 are configured to facilitate self-deployment of FMLG assembly 500 when doors 600 and 602 are opened. Side door 600 includes a connecting link 604 coupled to a portion of FMLG assembly 500. In the exemplary embodiment, link 604 is coupled to shock strut 502. Alternatively, link 604 may be coupled to any portion of FMLG assembly 500 that facilitates assembly 500 operation as described herein. When side door 600 is opened from release of the main landing gear locks (not shown), side door 600 rotates sufficiently about pivot line 522 to provide an added outward aerodynamic force on door 600. Moreover, link 604 pulls shock strut 502 such that forward and aft trunnion 520 pivots about line 522 and FMLG assembly 500 is pulled from storage area 508 into the wind stream simultaneously with the opening of door 600. In the exemplary embodiment, door 600 is a solid, one-piece door. Alternatively, door 600 may be a hinged folding door to enable landing without closing.

When FMLG assembly is fully deployed, rotation of FMLG assembly 500 about line 522 causes extension of shrink link 552 (not shown in FIGS. 8A-8D) and also causes lock actuator 560 (not shown in FIGS. 8A-8D) to lock lock links 540 and 542 in place. Removal of FMLG assembly 500 from storage area 508 further causes main actuator 558 to extend to allow for deployment, but main actuator 558 does not cause FMLG assembly 500 to be self-deployed. That is, main actuator 558 may typically be used but is not required to push FMLG assembly 500 from storage area 508 into the wind stream, as gravity with the side deploy gear motion and side door 600 aerodynamic load provide required alternate FMLG assembly 500 extension methods.

During the retraction process, lock links 540 and 542 unlock via lock actuator 560 allowing main actuator 558 to retract causing main trunnion brace 516 to pivot about line 522 and rotate relative to fuselage 510. Rotation of main trunnion brace 516 about line 522 also causes retraction of shrink link 552 and telescoping shock strut 502 until FMLG assembly 500 is fully retracted within storage area 508 of fuselage 406. During retraction, connecting link 604 is configured to pull door 600 closed as main actuator 558 retracts FMLG assembly 500 into storage area 508. In the exemplary embodiment door 602 is closed by an actuator (not shown) extending between door 602 and fuselage 510. Alternatively, door 602 may be closed in a manner similar to that of door 600, where a connecting link (not shown) extends between FMLG assembly 500 and door 602 to facilitate closing door 602 by FMLG assembly 500 motion.

In the exemplary embodiment, the range of motion of side door 600 during retraction and deployment of FMLG assembly 500 between when FMLG assembly 500 is in retracted position 503 (shown in FIG. 8A) and when FMLG assembly is in deployed position 501 (shown in FIG. 8D) is defined as door envelope 606, as shown in FIG. 8A. Door envelope 606 illustrates the range of movement of first door 600 between an open position 608 when FMLG assembly 500 is deployed and a closed position 610 when FMLG assembly 500 is retracted. Door envelope 606 facilitates door 600 clearance of FMLG assembly 500 in deployed position 501 and a trailing edge wing flap (not shown in FIGS. 8A-8D) in an extended position (not shown in FIGS. 8A-8D). Truck assembly 504 may also include a rotary or other actuator (not shown) to assist in placing FMLG assembly 500 in a fully stowed position such that wheels 514 of truck assembly 504 are rotated to occupy less space in storage area 508.

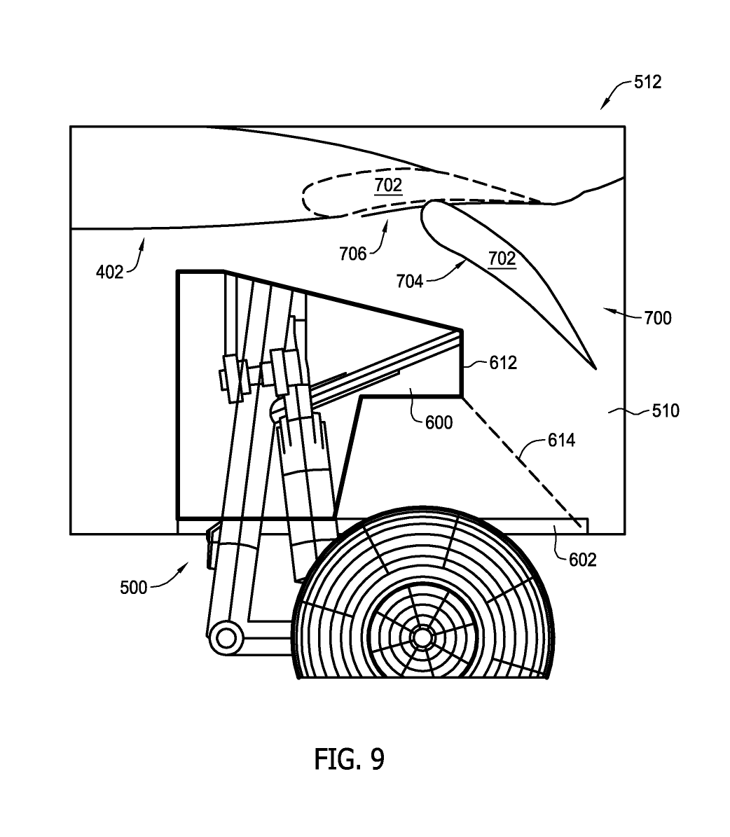

FIG. 9 is a side view of aircraft 512 having a low wing configuration 700 that includes FMLG assembly 500 and wing 402. Low wing configuration 700 facilitates deployment of FMLG assembly 500 and opening of doors 600 and 602 without interfering with any portion of wing 402. In the exemplary embodiment, configuration 700 includes a trailing edge flap 702 on inboard portion 412 (not shown in FIG. 9) of wing 402 configured to reduce the speed at which aircraft 512 can be safely flown and to increase the angle of descent approach for landing. Flap 702 is shown in an extended position 704 with solid lines and in a stowed position 706 with broken lines. In the exemplary embodiment, flap 702 is a solid-bodied, single-piece flap that is selectively moveable between stowed positioned 706 and extended position 704 without impeding with door envelope 606 (not shown in FIG. 9) or contacting door 600 or FMLG assembly 500. More specifically, when in extended position 704, flap 702 is aft of door envelope 606 and aft of an aft edge 612 of door 600. Known trailing edge flaps are commonly multi-part flaps that require folding or contracting to allow landing gear to deploy, and further require complex sequencing to avoid flap/gear interference. However, single-piece flap 702 does not require the components to facilitate such folding or contracting, and, as such, has a reduced weight, which contributes to increasing aircraft 512 efficiency.

In the exemplary embodiment, configuration 700 facilitates coupling FMLG assembly 500 to fuselage 510 in a position forward of flap 702 such that when FMLG assembly 500 is deployed and door 600 is open, flap 702 extends in the aft direction around door 600. More specifically, in the exemplary embodiment, side brace 538 (not shown in FIG. 9) extends in a forward direction and is coupled to support 548 (not shown in FIG. 9) in a position that is forward from known low wing landing gear configurations. Furthermore, because FMLG assembly 500 is coupled to fuselage 510 as opposed to wing 402, as in known low wing configurations, FMLG assembly 500 may be installed onto fuselage 510 prior to installing wings 402 during the aircraft build assembly process. In the exemplary embodiment, the shape of door 600 is optimized to facilitate flap 702 clearance and to provide a minimum profile in the wind stream outboard of fuselage 510 when in open position 608 (not shown in FIG. 9). Alternatively, door 600 may be sized larger, as shown by an alternate aft edge 614 in broken lines, to facilitate increased compression stroke of shock strut 502 that facilitates minimizing the size of fairing 562 to increase aircraft 512 efficiency. In the exemplary embodiment, configuration 700 facilitates isolating flap 702 from door envelope 606 and FMLG assembly 500 such that flap 702 may be deployed simultaneously with, before, or after deployment of FMLG assembly 500 and opening of door 600.

The assemblies and methods described herein facilitate increasing the efficiency of a low wing aircraft wing. More specifically, the assemblies described herein include a fuselage mounted landing gear and wing configuration on a low wing aircraft that facilitates decreasing the inboard area of the wing to improve wing efficiency as compared to known low wing aircraft configurations. Furthermore, the fuselage mounted landing gear is coupled to the fuselage of the aircraft in a minimum sized forward stowed wheel position as compared to known fuselage landing gears. The relative position of the fuselage mounted landing gear assembly described herein enables the aircraft wing to use a multi or simple single-piece trailing edge flap that extends around a minimized deployment envelope defined by the landing gear doors. The assemblies and methods described herein are used with a low wing configuration that enables integrating and assembling a fuselage mounted landing gear on a low wing aircraft such that the efficiency of the aircraft is facilitated to be increased by reducing the inboard area of the wing, by reducing the weight of the landing gear assembly and wing, and by enabling a simplified trailing edge flap deployment that prevents conflict between the flap and landing gear doors.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A landing gear assembly for use with a low wing aircraft, said landing gear assembly comprising:
a truck assembly;
a shock strut coupled to said truck assembly, said shock strut configured to support said truck assembly; and
a retraction assembly coupled to said shock strut and to said truck assembly, said retraction assembly configured to selectively move said landing gear assembly between a retracted position and a deployed position, said retraction assembly comprising a main trunnion brace having a first end and a second end, said first end is coupled to a fuselage of the aircraft at a first pivot point, said second end is coupled to said truck assembly, said main trunnion brace is configured to position said truck assembly, said shock strut, and said retraction assembly fully within the fuselage of the aircraft with a side pivoting motion.

2. The landing gear assembly in accordance with claim 1, wherein said retraction assembly includes a side brace comprising a first end, a second end, and a body extending therebetween, wherein said side brace first end is pivotally coupled to said main trunnion brace second end and said side brace second end is pivotally coupled to the fuselage at a second pivot point that is forward of first pivot point.

3. The landing gear assembly in accordance with claim 2, wherein a pair of lock links are pivotally coupled between said side brace body and said main trunnion brace.

4. The landing gear assembly in accordance with claim 1, wherein said truck assembly is positioned sufficiently outwardly in the deployed position to prevent the aircraft from tipping during taxiing.

5. The landing gear assembly in accordance with claim 1, wherein said retraction assembly includes a shrink link pivotally coupled between said shock strut and said main trunnion brace.

6. The landing gear assembly in accordance with claim 1 further comprising a fusing track coupled to the fuselage proximate said first pivot point, said fusing track configured to guide said main trunnion brace outward from fuselage.

7. The landing gear assembly in accordance with claim 1, wherein said main trunnion brace is coupled to the fuselage wherein first pivot line is positioned forward of a trailing edge wing flap to prevent contact between said trailing edge wing flap and said truck assembly, said shock strut, or said retraction assembly.

8. An aircraft comprising:
at least one wing comprising a trailing edge flap that is selectively moveable between a stowed position and an extended position;
a fuselage comprising a first gear door on a side of said fuselage and a second gear door on a bottom of said fuselage, said first gear door is moveable in a gear door envelope between a closed position and an open position, wherein said at least one wing is coupled to said fuselage in a low wing configuration; and
a landing gear assembly coupled to said fuselage and selectively moveable between a retracted position and a deployed position, wherein said trailing edge flap may be extended simultaneously with, before, or after deployment of said landing gear assembly and opening of said first gear door.

9. The aircraft in accordance with claim 8, wherein said first gear door is configured to facilitate deployment of said landing gear assembly when said first gear door is opened.

10. The aircraft in accordance with claim 9, wherein said first gear door includes a connecting link coupled to said landing gear assembly, said connecting link configured to remove said landing gear assembly from a storage area within said fuselage.

11. The aircraft in accordance with claim 10, wherein said connecting link is configured to close said first gear door during retraction of said landing gear assembly into said storage area.

12. The aircraft in accordance with claim 8, wherein said landing gear assembly is coupled to said fuselage before said at least one wing.

13. The aircraft in accordance with claim 8, wherein said trailing edge flap is a solid-bodied, single-piece flap, that is coupled adjacent a rear spar of a wing main box and is selectively moveable between the stowed position and the extended position without impeding said door envelope or contacting said landing gear assembly.

14. The aircraft in accordance with claim 8, wherein said wing includes a wing planform area having a reduced inboard portion and increased outboard portion that facilitates more efficient outboard wing load distribution.

15. The aircraft in accordance with claim 8, wherein the extended position of said trailing edge flap is aft of said first gear door envelope and an aft edge of said first gear door.

16. A method of enhancing the maneuverability and efficiency of an aircraft, said method comprising:
providing a fuselage including a first gear door on a side of the fuselage and a second gear door on a bottom of the fuselage, wherein the first gear door is moveable in a gear door envelope between a closed position and an open position;
coupling a landing gear assembly to the fuselage, wherein the landing gear assembly is selectively moveable between a retracted position and a deployed position;
coupling at least one aft swept wing to the fuselage in a low wing configuration, wherein the at least one wing includes a trailing edge flap coupled adjacent a rear spar of a wing main box, wherein the trailing edge flap is selectively moveable between a stowed position and an extended position, wherein the trailing edge flap may be extended simultaneously with, before, or after deployment of the landing gear assembly and opening of the first gear door.

17. The method in accordance with claim 16, wherein coupling at least one wing to the fuselage includes coupling the at least one wing to the fuselage such that the extended position of the trailing edge flap is aft of the first gear door envelope and an aft edge of the first gear door.

18. The method in accordance with claim 16 further comprising coupling the landing gear assembly to the fuselage before coupling the at least one wing to the fuselage.

19. The method in accordance with claim 16 further comprising coupling a connecting link between the first gear door and the landing gear assembly to facilitate removing the landing gear assembly from the fuselage during deployment of the landing gear assembly and to facilitate closing the first gear door during retraction of the landing gear assembly.

20. The method in accordance with claim 16 further comprising optimizing a wing planform to reduce an inboard portion of the wing and increase an outboard portion of the wing to facilitate increasing an efficiency of the wing area distribution.
